(19) United States
(12) Patent Application Publication
(10) Pub. No.: US 2003/0094570 A1
(43) Pub. Date: May 22, 2003

(54) Selective ion source for high intensity focused and collimated ion beams - coupling with high resolution cycloidal path sector

(76) Inventor: Robert Evrard, Nesles La Vallee (FR)

Correspondence Address: Jonathan P. Osha, Rosenthal & Osha L.L.P., 1221 McKinney, #2800, Houston, TX, 77010, US

(21) Appl. No.: 10/273,729

(22) Filed: Oct. 18, 2002

(30) Foreign Application Priority Data
Oct. 19, 2001 (FR) FR0113488

(51) Int. Cl. H01J 49/32

(52) U.S. Cl. 250/296; 250/288

(57) ABSTRACT

A mass spectrometer is described in which the ions are submitted to the action of a uniform adjustable electrical field \vec{E}₁, within a set of plane parallel electrodes a₁, . . . , a_{i,} . . . aₙ fitted with properly located slits for the ions transmission, and to the action of a uniform magnetic induction \vec{B}₁. A reference system x,y is considered in a plane perpendicular to \vec{B}₁, the axis x and y being respectively perpendicular and parallel to \vec{E}₁, and the origin of the reference system being fixed at an average starting point of the ions. The crossed fields \vec{E}₁,\vec{B}₁, act together in an area where y<d and the magnetic induction \vec{B}₁ acts alone in a further area where y>d, d being a distance separating the average starting point of the ions from the electrode αₙ. The selection slit S₁ is located at coordinates x=2.1d and y=2d, and the value of E₁ that is applied for the selection of the ions having the number of mass n is defined by

$${E}_{1} = \frac{2 d}{n} \frac{e}{m} {B}_{1}^{2} ,$$

with

$$\frac{e}{m}$$

with e/m corresponding to a ratio charge/mass for H⁺. The ions are created by electronic bombardment only in the vicinity of a plane parallel to \vec{B}₁, making an angle of 45° with \vec{E}₁, and a heated filament F for emitting electrons being stretched above the electrodes a₁,a₂, such that a resulting selected ion beam is parallel to the x axis when crossing S₁. The ion beam may feed, under optimal conditions, a “cycloid path” mass spectrometer or a 90° magnetic sector. The system provides improved sensitivity and a high resolution within a small and very simple instrument.

### BACKGROUND OF THE INVENTION

Ions sources known from prior art, as described for example in the publication “Electron Optics” by Pierre Grivet, are subject to a number of limitations.

In order to minimize the energy dispersion of ions generated in the ions source, the ionisation space is reduced.

As a result, ionisation cells may be nearly closed and the ions extraction has a rather poor yield.

In case that it is required to improve the collimating, this may be achieved by a selection through a number of narrow slits.

However introducing selection and reducing the ionisation space may drastically reduce the sensitivity to a value in the order of 10⁻⁴ A/Torr or less, with the exception of very big instruments.

The applicant has earlier described a high intensity selective ion source in a French patent application Nr 0009081 filed 17 Jul. 2000, in which ions created by electronic bombardment in a large volume and having the same number of mass n, can be focused on a narrow slit S₁ in order to obtain an emerging ion beam

### SUMMARY OF THE INVENTION

In a first aspect the invention provides a mass spectrometer in which the ions are submitted to the action of a uniform adjustable electrical field E₁, within a set of plane parallel electrodes a₁, . . . , a_{i,} . . . aₙ fitted with properly located slits for the ions transmission, and to the action of a uniform magnetic induction \vec{B}₁. A reference system x,y is considered in a plane perpendicular to \vec{B}₁, the axis x and y being respectively perpendicular and parallel to \vec{E}₁, and the origin of the reference system being fixed at an average starting point of the ions. The crossed fields \vec{E}₁,\vec{B}₁, act together in an area where y<d and the magnetic induction \vec{B}₁ acts alone in a further area where y>d, d being a distance separating the average starting point of the ions from the electrode aₙ. The selection slit S₁ is located at coordinates x=2.1d and y=2d, and the value of E₁ that is applied for the selection of the ions having the number of mass n is defined by E₁=

$${E}_{1} = \frac{2 d}{n} \frac{e}{m} {B}_{1}^{2} , with \frac{e}{m}$$

corresponding to a ratio charge/mass for H⁺. The ions are created by electronic bombardment only in the vicinity of a plane parallel to \vec{B}₁, making an angle of 45° with \vec{E}₁, and a heated filament F for emitting electrons is stretched above the electrodes a₁,a₂, along a line where x=y, the electron beam being limited by a flat rectangular diaphragm parallel to F and located between F and the electrodes a₁,a₂, such that a resulting selected ion beam is parallel to the x axis when crossing S₁.

In a preferred embodiment of the invention, the ions are submitted to a second couple of crossed fields \vec{E}₂,\vec{B}₁, at the exit S₁, \vec{E}₂ being created within a second set of plane parallel electrodes b₁, . . . , bᵢ, . . . bₙ, also fitted with properly located slits for the ions transmission. A value of the electric field E₂ is equal to E₁ cos 45° and a direction of the electric field E₂ makes an angle of 45° with E₁. A second selection slit S₂ is located on the cycloid path on the electrode bₙ at a point defined by coordinates X≅8.9d and Y=0 in a further reference system that is defined by axis X and Y, wherein the X axis and the Y axis are respectively perpendicular and parallel to E₂. An origin of the further reference system is fixed at S₁.

### BRIEF DESCRIPTION OF THE FIGURES

The invention will now be described in greater detail with reference to the accompanying drawings, in which

FIG. 1 contains an illustration of an embodiment of a mass spectrometer in accordance with the invention,

FIG. 2 contains an illustration of an embodiment of a mass spectrometer in accordance with the invention,

FIG. 3 contains an illustration of an embodiment of a mass spectrometer in accordance with the invention.

### EXAMPLES OF PREFERRED EMBODIMENTS

We will now describe examples of systems that bring important improvements to the systems known from prior art. One advantage of the described examples is that they allow the emerging ion beam to be well collimated. The collimated emerging ion beam provides a powerful ion source that can then feed, in optimal conditions, a “cycloid path” mass spectrometer or a 90° magnetic sector fitted with a very narrow gap.

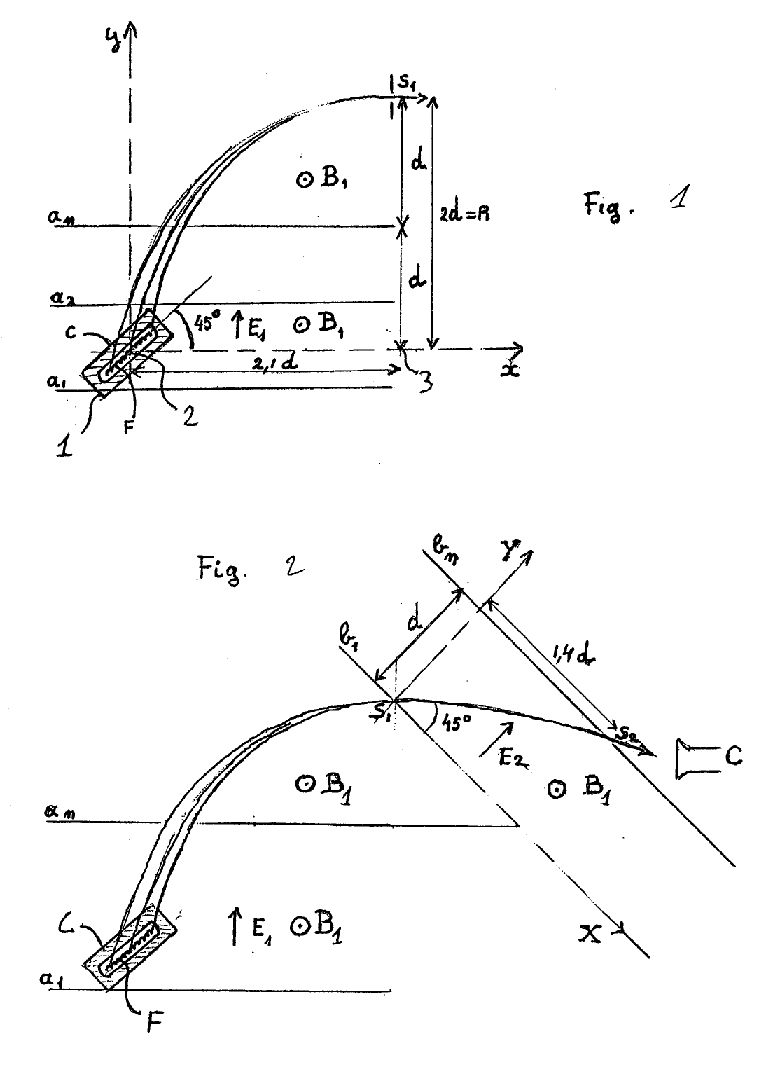

Referring to FIG. 1, ions created by electronic bombardment in an ions source 1 are submitted to the action of a uniform adjustable electrical field \vec{E}₁, between a set of plane parallel electrodes a₁, a₂, . . . , aₙ fitted with properly located slits for the transmission of the ions.

The ions are also submitted to the action of a fixed uniform magnetic induction \vec{B}₁, that is perpendicular to \vec{E}₁, created by an external magnetic circuit sandwiching a box of the instrument (not shown in FIG. 1).

We will use a reference system defined by two axis x,y in a plane perpendicular to \vec{B}₁, the axis x and y being respectively perpendicular and parallel to \vec{E}₁, and an origin of the reference system being fixed at a determined average starting point 2 of the ions source 1.

The electrical field \vec{E}₁ and the magnetic induction \vec{B}₁ act in a first area where the value of y verifies

y<d

d being a distance separating the determined average starting point 2 from the electrode aₙ.

The magnetic induction \vec{B}₁ acts alone in a second area where the value of y verifies

y>d.

The ions follow a cycloid path in the first area (y<d) and a circular path with a radius of curvature R in the second area (y>d).

For the ions having a number of mass n and for

$${\vec{E}}_{1} = \frac{2 d ω B}{n} ( in which ω = \frac{e}{m} B , with \frac{e}{m} being the ratio of charge to mass for the hydrogen ion {H}^{+} ) ,$$

being the ratio of charge to mass for the hydrogen ion H⁺), the radius of curvature R is:

R=2d

The centre of curvature 3 having coordinates (x₀,y₀) in the reference system is located at a point defined as follows:

x₀=2.1d=1.05R, and

y₀=0.

A selection slit S₁, is located at a point having following coordinates:

x=2.1d=1.05R, and

y=2d=R.

For the proper determined value of \vec{E}₁, the ions n cross the selection slit S₁, the trajectories of the ions being at this point parallel to the x axis.

Let us consider now the case where the starting point for the ions varies from (0.0) to (Δx,Δy), Δx and Δy being relatively small in regard of R.

Varying Δx only will just cause a simple translation Δx of the trajectory. The new centre of curvature having coordinates (x_{Δx},y_{Δx}) will be located at following coordinates:

x_{Δx}=1.05R+Δx, and

y_{Δx}=0.

The ions are still crossing S₁, but their trajectories make at this point an angle α=Δx/R with the x axis.

Varying Δy only, modifies the interval d where \vec{E}₁ is acting, and of course the ions speed and the radius of curvature of the trajectories. We have:

$$\frac{R + Δ R}{R} = {( \frac{d - Δ y}{d} )}^{\frac{1}{2}} = {( \frac{R - 2 Δ y}{R} )}^{\frac{1}{2}} \to Δ R = - Δ y$$

Accordingly the new centre of curvature having coordinates (x_{Δy},y_{Δy}) is located as follows:

x_{Δy}=1.05R−Δy and

y_{Δy}=Δy.

The ions n are still crossing S₁ but at this level, the trajectories are making an angle

$$α = - \frac{Δ y}{R}$$

with the x axis.

So if we take in account both a variation of Δx and Δy, the centre of curvature having coordinates (x_{ΔxΔy}, y_{ΔxΔy}) is located as follows:

x_{ΔxΔy}=1.05R+Δx−Δy, and

y_{ΔxΔy}=Δy,

the radius of curvature being equal to R−Δy.

The trajectories at the level S₁ make an angle

$$α = \frac{Δ x - Δ y}{R}$$

with the x axis.

IMPORTANT PARTICULAR CASE: Δx=Δy and α=o.

This case corresponds to the ions created in the vicinity of a plane parallel to \vec{B}₁ intersecting the plane xy following a line x=y . All of these ions having the number of mass n, crossing S₁ for

$${E}_{1} = \frac{2 d ω {B}_{1}}{n} = \frac{R ω {B}_{1}}{n} ,$$

will have their trajectories at the level S₁ perfectly parallel to the x axis.

A setting allowing the creation of only these ions and so, to obtain at the exit S₁ a perfectly collimated beam, can be very simple.

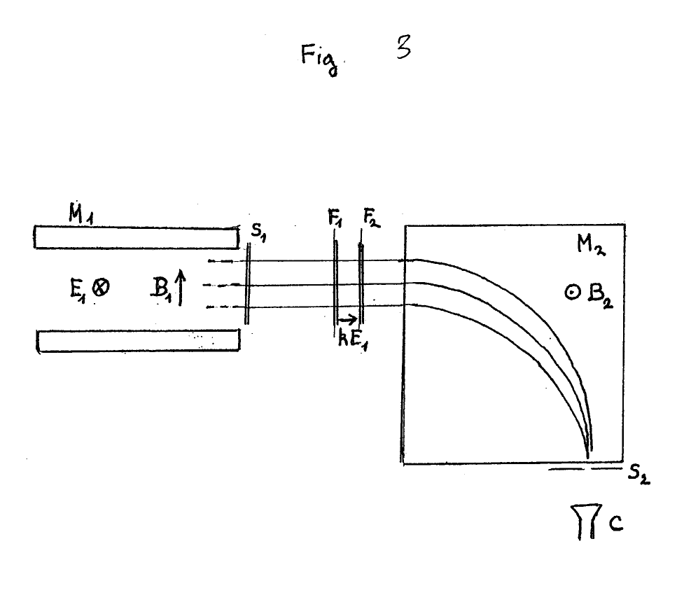

Referring to FIG. 2, a heated filament F, emitter of the ionising electrons, is stretched above the electrodes α₁,α2, following a line x=y. The electron beam generated by the heated filament F is limited by a flat small electrode C, fitted with a narrow rectangular diaphragm, parallel to F and located between F and α₁,α₂.

We will now describe the introduction of the collimated ion beam in a “cycloid path” sector, where the ions will be submitted to the action of a second couple of crossed fields \vec{E}₂,\vec{B}₁.

The field \vec{E}₂ will be equal to \vec{E}₁ cos 45° and will make an angle of 45° with \vec{E}₁ and with the ion beam at S₁. We will use for this sector a second reference system X, Y in the same plane perpendicular to \vec{B}₁. The X- and Y-axis are respectively perpendicular and parallel to \vec{E}₂ and the origin is fixed at S₁.

\vec{E}₂ is established within a set of plane parallel electrodes b₁, . . . bᵢ . . . , bₙ.

The initial speed v of the ions is given by:

$$v = {( \frac{2 {eE}_{1} d}{nm} )}^{\frac{1}{2}} = \frac{R ω}{n} = \frac{{E}_{1}}{{B}_{1}}$$

So, the components X′ₒ and Y′ₒ of v are given by

$${X}_{0}^{′} = {Y}_{0}^{′} = \frac{{E}_{1}}{{B}_{1}} cos {45}^{°} = \frac{{E}_{2}}{{B}_{1}} .$$

Due to the different starting points of the ions in the source, these values are only an average but ΔX′ₒ is always equal to ΔY′ₒ.

The equations of the trajectories are, in general:

$$X = \frac{n}{ω} {Y}_{0}^{′} ( 1 - cos \frac{ω t}{n} ) - \frac{n}{ω} ( - {X}_{0}^{′} + \frac{{E}_{2}}{{B}_{1}} ) sin \frac{ω t}{n} + \frac{n}{ω} \frac{{E}_{2}}{{B}_{1}} \frac{ω t}{n}$$

$$Y = \frac{n}{ω} {Y}_{0}^{′} ( sin \frac{ω t}{n} ) + \frac{n}{ω} ( - {X}_{0}^{′} + \frac{{E}_{2}}{{B}_{1}} ) ( 1 - cos \frac{ω t}{n} )$$

The conditions of unicity of the trajectories for small variations of X′ₒ and Y′ₒ are:

$$\frac{\frac{δ Y}{δ {X}_{0}^{′}}}{\frac{δ X}{δ {X}_{0}^{′}}} = \frac{\frac{δ Y}{δ {Y}_{0}^{′}}}{\frac{δ X}{δ {Y}_{0}^{′}}} = \frac{\frac{δ Y}{δ t}}{\frac{δ X}{δ t}}$$

It is easy to check that, for

$${X}_{o}^{′} = {Y}_{o}^{′} = \frac{{E}_{2}}{{B}_{1}}$$

and ΔX′ₒ=ΔY′ₒ these conditions are always fulfilled. All the ions n of the collimated beam at the exit of S₁ will follow exactly the same path, even when having different initial energies.

Of course, for the same value of E₂, the ions having a number of mass ≠n, i.e. having a value different from n, will follow different paths and be discarded.

We did not take in account the adverse effect of the random initial energy of the ions when created in the source. This energy, for “fragment ions” can be of the order of 1 eV.

The trajectories of those ions are not collimated at the exit S₁ but converge towards the ideal trajectory. Detailed computations show that they will cross it at a point of coordinates X≅1.5d and Y≅d.

In any case, it is well known that in a “cycloid path” mass spectrometer, the ions are perfectly focused, after a flying time

$$t = \frac{2 Π n}{ω} ,$$

on a line having, in our case, the coordinates X=8.9d and Y=O. This final decision slit S₂ is, of course, located there.

A different coupling can be done easily with a classical 90° magnetic sector. This is shown in the example illustrated in FIG. 3. The ion beam at the exit S₁ of the ion source has the geometry of a flat planar ribbon that can be introduced in the narrow gap of a magnetic circuit M₂.

Due to the small gap, the magnetic induction \vec{B}₂ can be much larger than \vec{B}₁ in the first magnetic circuit M₁. \vec{B}₂ is perpendicular to the plane of the ion beam and to \vec{B}₁, and so are the two magnetic circuits M₁, M₂.

In the gap of M₂, the ions n will follow circular trajectories having a radius

$${R}_{2} = 2 d \frac{{B}_{1}}{{B}_{2}} .$$

As B₂>>B₁, R₂ is much smaller than R₁. In order to increase R₂ (and the resolution) it is easy to increase the ions energy with an accelerating electrical field E₂=kE₁, between two electrodes F₁ and F₂ separated by a distance pd and located between the to magnetic circuits M₁,M₂. The initial energy of the ions having the mass number n when entering the gap in M₂ will be then equal to

eE₁d(1+kp)

The radius of curvature R₂ of their paths will be, all computations done,

$${R}_{2} = 2 d \frac{{B}_{1}}{{B}_{2}} {( 1 + kp )}^{\frac{1}{2}}$$

A final selection hole S₂ is located at X=Y=R₂ where the ion beam section is reduced to a point.

Numerical Application

Let us choose B₂=3B₁ R₂=R₁=2d p=0.5.

In this case the value of k is as follows: k=16. It is easy to check that, with these values, the aberrations at S₂ are negligible.

Behind S₂, a Faraday cup or an internal amplifier C (a channeltron for instance) will receive the selected ion beam. The sensibility is always limited by the grossly continuous noise of the amplifier. But, if the ion beam is modulated by a grid α, located for instance at S₁ and polarised at an alternative potential with a fixed frequency, the useful signal can be detected and amplified independently of the noise. The ratio signal to noise can be greatly improved.

### CONCLUSION

This very simple system has both high sensitivity and high resolution.

The high sensitivity is mainly due to the fact that the ionisation volume is large and to the fact that the Open geometry of the system allows a complete extraction of the ions.

The high resolution is mainly due to the fact that the second selection sector is fed by a preselected collimated ion beam.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A mass spectrometer in which the ions are submitted to the action of a uniform adjustable electrical field \vec{E}₁, within a set of plane parallel electrodes a₁, . . . , a_{i,} . . . aₙ fitted with properly located slits for the ions transmission, and to the action of a uniform magnetic induction \vec{B}₁, wherein a reference system x,y is considered in a plane perpendicular to \vec{B}₁, the axis x and y being respectively perpendicular and parallel to \vec{E}₁, and the origin of the reference system being fixed at an average starting point of the ions,
the crossed fields \vec{E}₁,\vec{B}₁ acting together in an area where y<d and the magnetic induction \vec{B}₁ acting alone in a further area where y>d, d being a distance separating the average starting point of the ions from the electrode aₙ,
the selection slit S₁ being located at coordinates x=2.1d and y=2d, and
the value of E₁ that is applied for the selection of the ions having the number of mass n being defined by
$${E}_{1} = \frac{2 d}{n} \frac{e}{m} {B}_{1}^{2} , with \frac{e}{m}$$
corresponding to a ratio charge/mass for H⁺, further wherein
the ions are created by electronic bombardment only in the vicinity of a plane parallel to \vec{B}₁, making an angle of 45° with \vec{E}₁, and a heated filament F for emitting electrons being stretched above the electrodes a₁,a₂, along a line where x=y, the electron beam being limited by a flat rectangular diaphragm parallel to F and located between F and the electrodes a₁,a₂, such that a resulting selected ion beam is parallel to the x axis when crossing S₁.

2. A mass spectrometer according to claim 1, wherein at the exit S₁, the ions are submitted to a second couple of crossed fields \vec{E}₂,\vec{B}₁, \vec{E}₂ being created within a second set of plane parallel electrodes b₁, . . . , bᵢ, . . . bₙ, also fitted with properly located slits for the ions transmission, a value of the electric field E₂ being equal to E₁ cos 45° and a direction of the electric field E₂ making an angle of 45° with E₁,
a second selection slit S₂ being located on the cycloid path on the electrode bₙ at a point defined by coordinates X≅8.9d and Y=0 in a further reference system defined by axis X and Y, wherein the X axis and the Y axis are respectively perpendicular and parallel to E₂and an origin of the further reference system is fixed at S₁.

3. A mass spectrometer according to claim 1, wherein after the selection slit S₁, the ions are accelerated by an electrostatic field \vec{E}₂, and introduced in a narrow gap of a magnetic circuit M₂ where the magnetic induction B₂ is perpendicular to B₁ and so are the magnetic circuits M₂ and M₁, a final selecting hole being located at a point having coordinates X=Y=R₂, R₂ being a radius of curvature for the ions trajectories corresponding to the selected number of mass n.

4. A mass spectrometer according to anyone of claims 1 to 3, wherein the ion beam intensity is modulated by a grid located on the ions trajectory, and polarized at a fixed frequency, the useful signal being then detected independently of the continuous noise.
